(19) United States
(12) Patent Application Publication
(10) Pub. No.: US 2009/0066129 A1
(43) Pub. Date: Mar. 12, 2009

(54) Rigid Mounting Device for a Child Safety Seat with a hook connection

(76) Inventor: Joseph Wayne Kraft, College Station, TX (US)

Correspondence Address: FURR LAW FIRM, 2622 DEBOLT ROAD, UTICA, OH, 43080, US

(21) Appl. No.: 11/850,681

(22) Filed: Sep. 6, 2007

(51) Int. Cl. B60N 2/26

(52) U.S. Cl. 297/256.15; 297/238

(57) ABSTRACT

The present invention is a mounting device for a child safety seat. The child seat attaches to a motor vehicle seat through the use of mounting hooks attached to mounting brackets and mounting spikes that go through a set of receiver holes in the automobile seat. The mounting spikes connect the safety seat frame to the motor vehicle seat. The mounting spikes have spring-loaded securing latches that secure the child seat to the motor vehicle seat. The child seat will have a release mechanism that will quickly and easily release the mounting spikes from the seat to allow the child safety seat to be removed from the vehicle.

### CROSS-REFERENCES TO RELATED APPLICATIONS (IF ANY)

None

### STATEMENT AS TO RIGHTS TO INVENTIONS MADE UNDER FEDERALLY-SPONSORED RESEARCH AND DEVELOPMENT (IF ANY)

None

### BACKGROUND OF INVENTION

1. Field of the Invention

The present invention is directed to a Rigid Mounting Device for a Child Safety Seat, more particular to one that attaches directly to a seat with a hooking bracket.

2. Background

Most states have laws that require children below a certain weight or younger than a certain age be placed in an approved child safety seat while riding in a motor vehicle. This requirement has been in place for over twenty years.

Child seats that are available today are difficult to use and to properly secure to the seat of the motor vehicle. The current systems are cumbersome to use and install.

Recent safety studies have shown that the addition of a top tether connecting the child seat to the motor vehicle seat is a better restraining system than securing just the bottom of the seat only. All seats being produced right now require that top tether is provided.

There needs to be a better mounting device to mount child safety seats to motor vehicles seats, a way that is quick but provides a secure and safe connection.

3. Prior Art

U.S. Pat. No. 5,730,493 by Fornasari, et al. and issued on Mar. 24, 1998, is for a built-in baby seat for transport in vehicles. It discloses a built-in baby seat including a retractable seat, which can be made of fabric, leather, synthetic leather, plastic, or any other similar material. The seat includes a mounting bar that can be shaped as a semiarch, a semicircle, a semiquadrangle, a semirectangle or semitriangle. The bar is made of iron, aluminum, plastic or any similar material, and is covered with plastic foam and/or rubber, which is in turn covered with some finishing material (leather, fabric, synthetic leather, plastic, or the like).

U.S. Pat. No. 5,716,097 by Peck, et al. and issued on Feb. 10, 1998, is for a retractor plate for integral child restraint seat. It discloses a child restraint assembly that is integrated into the backrest portion of a passenger seat in motor vehicle.

U.S. Pat. No. 5,429,414 by Olsson, et al. and issued on Jul. 4, 1995, relates to a child seat. It discloses a seat for a vehicle comprising a main or “adult” seat incorporating an integrated child seat.

U.S. Pat. No. 5,224,756 by Dukatz, et al. and issued on Jul. 6, 1993, is for an Integrated child seat for vehicle. It discloses a three-mode seat for a motor vehicle cooperable with an adult seat belt assembly to provide three modes of operation including an adult seat mode, a large child booster seat mode, and a small child mode.

U.S. Pat. No. 5,100,199 by Vander Stel, et al. and issued on Mar. 31, 1992, is for a built-in infant seat. It discloses a seating unit for accommodating an adult in a seated position which has a child restraint seat convertible from a position stored within the back of the adult seat to a position for holding and restraining a child.

U.S. Pat. No. 5,026,118 by Vander Stel, et al. and issued on Jun. 25, 1991, is for a Built-in infant's seat for vehicles. It discloses a seating unit for accommodating an adult in a seated position and having a child restraint seat convertible from a position stored within the back of the adult seat to a position for holding and restraining a child.

U.S. Pat. No. 4,986,600 by Leblanc, et al. and issued on Jan. 22, 1991, is for a collapsible infant seat. It discloses a new and improved collapsible infant seat formed as part of a vehicle seat, the vehicle seat including a bench and an upright back, the collapsible seat including a seat portion connected at one end to the vehicle to be pivotable between an open position overlying the bench portion of the vehicle seat, and a closed position forming a lower part of the upright seat back, a seat back extending upwardly from the rearward edge of the seat portion, a pivotable bracket including a padded child restraint, a fastener for securing the seat in an open position and a harness for restraining the child within the seat.

U.S. Pat. No. 4,936,627 by Guim and issued on Jun. 26, 1990, is for a vehicle seat with built-in retractable child seat. The child seat includes a seat member and a back member pivotally mounted to each other and the main seat assembly includes a pivotally mounted platform cushion where the child seat is supported by a rail assembly that allows to slidably move back and forth.

U.S. Pat. No. 4,913,498 by Forlivio and issued on Apr. 3, 1990, is for a child restraint seat. It discloses a seat that includes dual child restraints which are selectively moveable to an extended position to provide either a restraint for an infant or small child, or a restraint for a larger child, the seat back including a fixed portion providing a back support for an infant or child which is extended in surface area upon retraction of one of the child restraint's to provide a comfortable back support for a larger child, the respective child restraints when retracted into the seat back providing a comfortable back support for an adult.

U.S. Pat. No. 4,900,087 by Crisp and issued on Feb. 13, 1990, is for an automobile seat with built in child seat.

U.S. Pat. No. 4,900,086 by Steward and issued on Feb. 13, 1990, is for an integral folding child restraint system. It discloses a child restraint system which is an integral part of and folded into a land vehicle or aircraft adult seat.

U.S. Pat. No. 4,768,827 by Musgrove and issued on Sep. 6, 1988, is for a stowable car seat for children. It discloses a seat assembly for vehicles such as automobiles or passenger trains that comprises a child-sized seat which is shiftable between an extended position for use atop an adult-sized chair, and a retracted position recessed within a chamber of the adult chair when use of the latter is instead desired.

U.S. Pat. No. 4,756,573 by Simin, et al. and issued on Jul. 12, 1988, is for a vehicle seat with built-in infant and toddler seat provisions.

U.S. Pat. No. 4,749,229 by Dorto and issued on Jun. 7, 1988, is for a child restraint seat. It discloses a child restraint seat that is designed for use with a conventional bench type vehicle seat. A pair of frame rods is rigidly mounted in a recess provided in the seat back of a conventional bench type vehicle seat. These rods extend parallel to the seat back and are rigidly connected to the bench type seat frame. One U-shaped support bracket is attached to each rod. A padded U-shaped restraint member has the free ends pivotally mounted in the U-shaped support brackets.

U.S. Pat. No. 4,690,455 by Bailey, et al. and issued on Sep. 1, 1987, is for an infant seat for automobiles. It discloses an infant seat for automobiles which includes a folding support hinged to a frame located in the bench seat or bucket seat backrest of an automobile and designed to support an infant or child when positioned in extended configuration.

U.S. Pat. No. 4,664,443 by Casale and issued on May 12, 1987, is for an automobile convertible seat. It discloses an automobile seat that includes a head rest for use by an adult which can be converted to an infant seat by pivoting a portion of the back rest forwardly and extending the infant or child seat from a storage compartment, and lowering the head rest which can be locked or secured to the child seat to serve as a restraint for the child.

U.S. Pat. No. 4,596,420 by Vaidya and issued on Jun. 24, 1986, is for a Built-in vehicle child's seat assembly. It discloses a child's seat assembly securable, preferably within the seat back of the backseat of a vehicle.

U.S. Pat. No. 4,555,135 by Freeland and issued on Nov. 26, 1985, discloses a built-in child's safety seat for vehicles. The safety seat may be conveniently stored within the horizontal sitting surface of a passenger seat when not in use. By a simple pulling motion, a child's safety seat is formed which provides more protection to the child and which is less prone to be misused.

U.S. Pat. No. 4,540,216 by Hassel, Sr. and issued on Sep. 10, 1985, is for a convertible seat for vehicles. It discloses a convertible seat for use by children in automobiles and other vehicles which is foldable and covered within the usual adult sized seating of the vehicle providing the usual appearance, and which is unfoldable and uncoverable to provide a simply constructed children's safety seat, upon and within the adult seating.

U.S. Pat. No. 4,533,176 by Wyttenbach and issued on Aug. 6, 1985, is for a built-in automatic infant restraint seat. It discloses a combination child's seat and adult seat for use in a vehicle. The combination comprises a seat member with a frame and a contact portion secured to the frame for receiving and contacting the body of a seated adult.

U.S. Pat. No. 4,402,548 by Mason and issued on Sep. 6, 1983, is for safety seats for vehicles. It discloses a safety seat for a vehicle of the type comprising a shell forming a seat portion, a back portion and two side portions, which are covered by a fabric seat cover, and is made adjustable in width by providing a plurality of filler strips which fit between the cover and the side portions of the shell so as to adjust the interior width of the seat.

U.S. Pat. No. 4,230,366 by Ruda and issued on Oct. 28, 1980, is for an automotive seat with built-in child restraint. It discloses an automotive vehicle seat that has a portion of its back part or seat part which can be pivoted or slid into a position above the sitting surface of the seat part and in front of the leaning surface of the back part. This portion is U-shaped and constitutes a passive child restraint having a pair of parallel legs extending in the direction of travel and a front cross piece, all padded. When out of use the U-shaped restraint bar may be pushed back level with the front surface of the back part of the seat or the top surface of the seat part of the seat.

There is still room for improvement in the art.

### SUMMARY OF THE INVENTION

The present invention is a mounting device for child safety seats. The child seat attaches to a motor vehicle seat through the use of hooking means attached to mounting brackets on the top and mounting spikes that go through a set of receiver holes in the automobile seat on the bottom. The mounting spikes rigidly connect the safety seat frame to the motor vehicle seat. The mounting spikes have securing latches that secure the child seat to the motor vehicle seat. The child seat will have a release mechanism that will release the mounting spikes from the seat.

The new invention will not require the securing of the child seat to the motor vehicle seat by use of seatbelts which can be troublesome to use and even when used properly, provide inadequate restraint for the child safety seat.

### BRIEF DESCRIPTION OF THE DRAWINGS

Without restricting the full scope of this invention, the preferred form of this invention is illustrated in the following drawings:

FIG. 1 displays the safety seat frame attaching to the motor vehicle seat;

FIG. 2 displays the child seat attached to the frame;

FIG. 3 displays a vertical view of the safety seat frame;

FIG. 4 displays the safety seat frame being attached to the motor vehicle seat; and

FIG. 5 displays the securing latches going into the receiving holes;

FIG. 6 displays the securing latches securing the child seat the motor vehicle seat;

FIG. 7 displays the securing latches; and

FIG. 8 displays the mounting hooks embodiment.

### BRIEF DESCRIPTION OF THE PREFERRED EMBODIMENTS

There are a number of significant design features and improvements incorporated within the invention.

The current invention is a child safety seat mounting device. The child seat 1 attaches to a motor vehicle seat 30 through the use of mounting hooks 125 connected to mounting brackets 126 and mounting spikes 15 that go through a set of receiver holes 12 in the automobile seat 10. The mounting spikes 15 connect the safety seat frame 25 to the motor vehicle seat 30. The mounting spikes 15 have securing latches 17 that secure the child seat to the motor vehicle seat 30. The child seat 1 will have a release mechanism 22 that will compress the securing latches 17 thereby releasing the mounting spikes 15 from the motor vehicle seat 30.

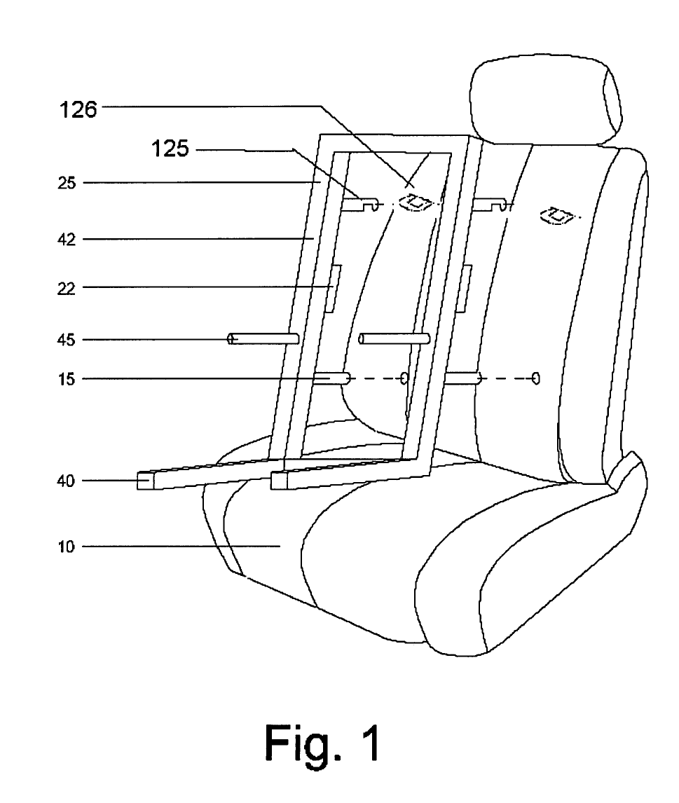

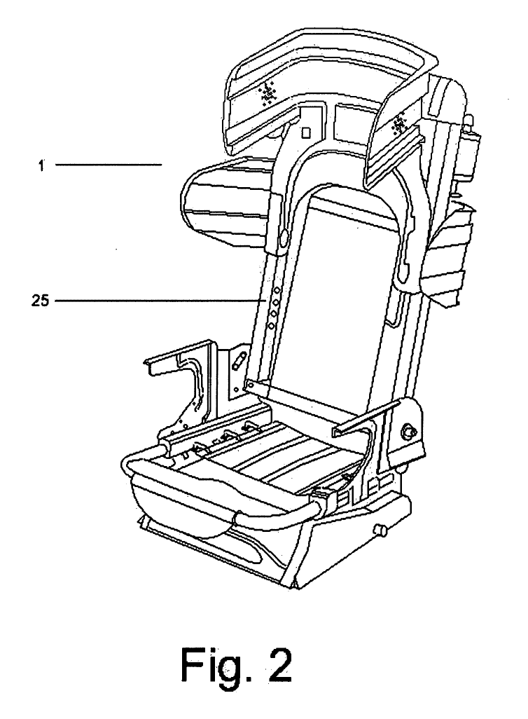

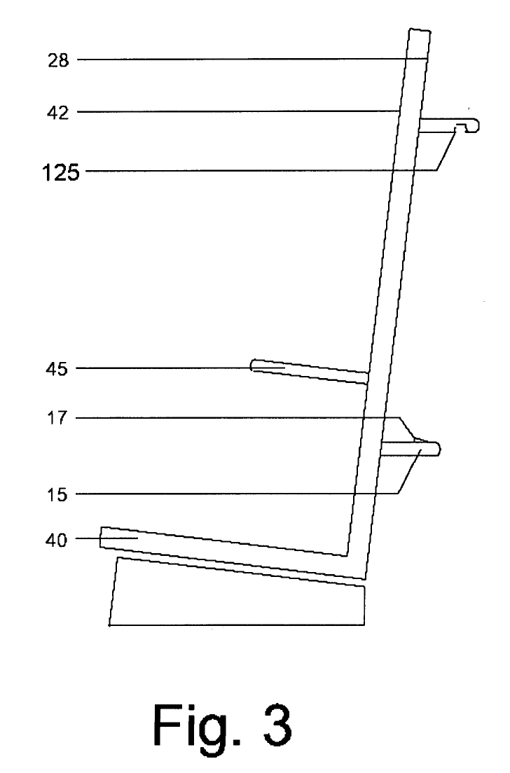

FIG. 1 displays one embodiment of the safety seat frame 25 attaching to the motor vehicle seat 30. The safety seat frame is the frame of a child seat 1. FIG. 2 displays a child seat 1 as it fits on the safety seat frame 25. While FIG. 3 displays a vertical view of the safety seat frame.

The safety seat frame 25 is rectangular in shape with a base support rectangle 42 with two bottom support bars 40 at the bottom at the base support rectangle 42 with two arm support bars 45 that are slightly midway up the base support rectangle 42. The arm support bars 45 and the bottom support bars 40 are at a slightly greater than 90 degree angle from the base support rectangle 42 and come out the front of the base support rectangle 42.

The mounting spikes 15 are circular in shape and come out the back of the base support rectangle 42. In the preferred embodiment there are two mounting spikes 15 evenly spaced on the bottom of the base support rectangle 42 for securing the child seat 1 to the motor vehicle seat 30. There are two mounting hooks 136 evenly spaced on the top of the base support rectangle 42. The mounting hooks 136 hook downwards.

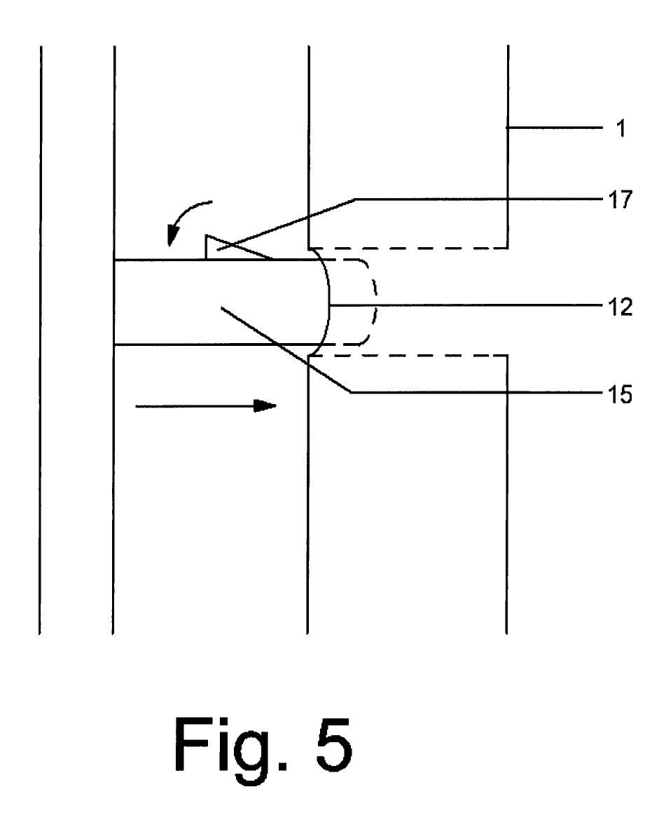

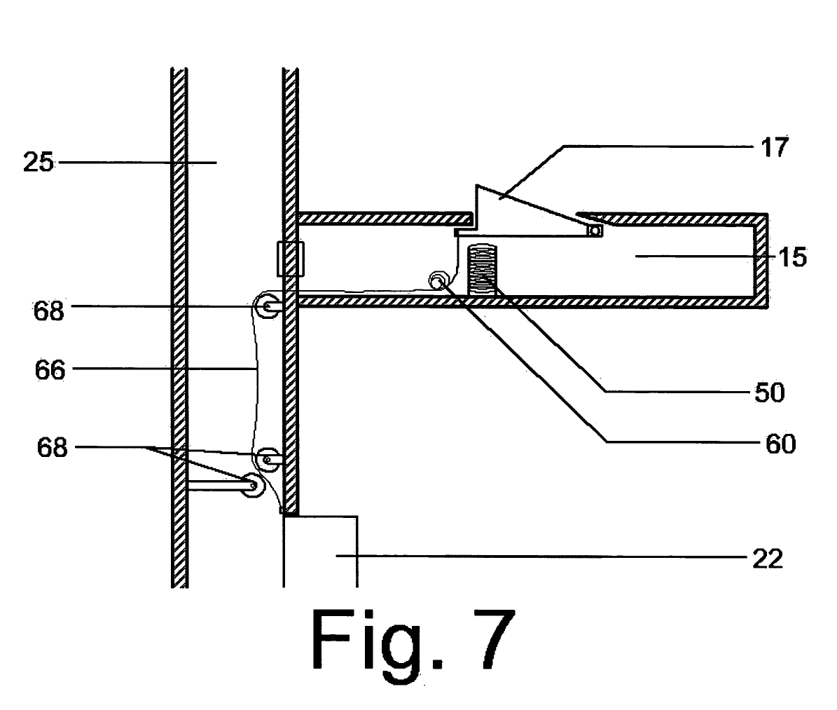

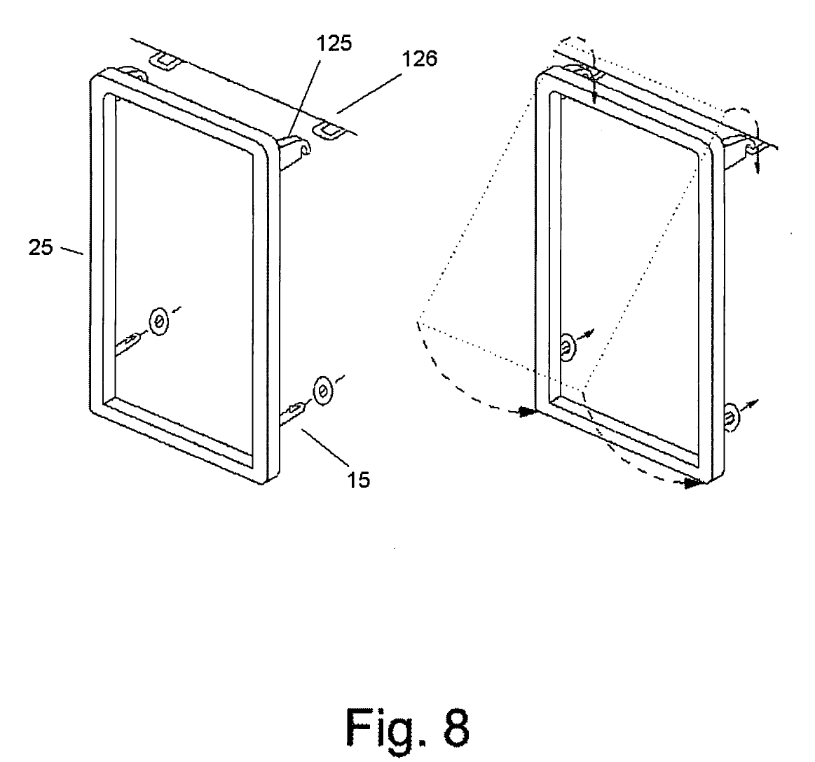

FIG. 8 displays the safety seat frame 25 being attached to the motor vehicle seat 30 using the mounting hooks 125. The safety seat frame 25 comes down so the mounting hooks 125 fit onto the mounting brackets 126 which are attached to the motor vehicle seat 30. The safety seat frame 25 is then swung down so that the mounting spikes 15 fit into the corresponding receiver holes 12. The receiver holes 12 have a diameter that is slightly bigger than the mounting spikes 15. FIG. 5 shows the mounting spikes 15 going into the receiver holes 12. The securing latches 17 compress against the mounting spikes 15 allowing the mounting spikes 15 to go through the receiver holes 12. As shown in FIG. 6, the securing latches 17 secure the child seat 1 through the safety seat frame 25. The flat 19 of the securing latch 17 secures against the back of the motor vehicle seat 30 securely holding the child seat 1 in place. The mounting brackets 126 are u shaped and extend out from the surface of the motor vehicle seat 30. The mounting brackets 126 are made of a strong material such as metal like steel.

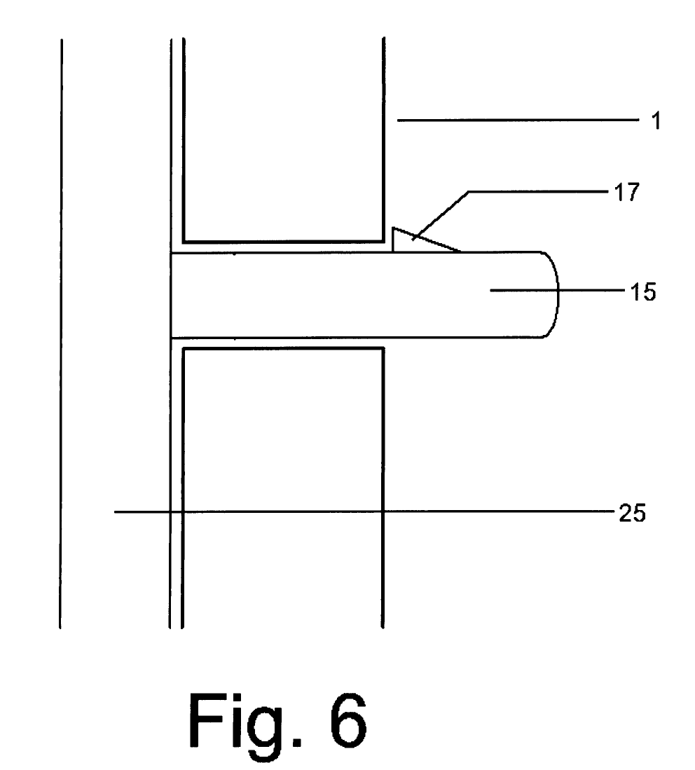

As shown in FIG. 7, the securing latches 17 are triangular in shape on a pivot with a tension means such as a spring 51. The tension means 51 apply force to the securing latch away from the mounting spike 15 in an open position. The securing latch 17 will have a stop 53 that will keep the securing latch 17 in the mounting spike 15.

To remove the child seat 1 from the motor vehicle seat 30, in the preferred embodiment there is a release mechanism 22 attached to the safety seat frame 25. By compressing the release mechanism 22 through a use of pulleys 68, cables 66 and levels will compress the securing latches 17 allowing a user to easily remove the child seat 1 from the motor vehicle seat 30. The securing latches 17 can also be compressed manually.

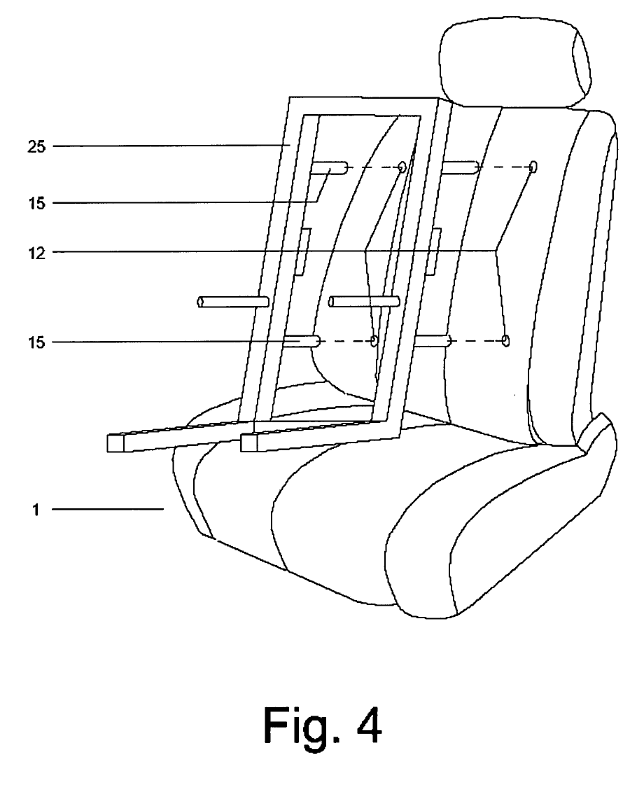

FIG. 4 displays an alternative embodiment where the safety seat frame 25 being attached to the motor vehicle seat 30 without the mounting hooks 125 but with only mounting spikes.

The safety seat frame 25 in the preferred embodiment would be composed of a structurally sound material and light weight material such as aluminum,

The current invention is an improvement over prior art as it is a system and design that rigidly mounts the entire child safety seat including the upper part of the seat back to the vehicle seat. This is important due to the recently developed top tether that has been shown to be a better restraint than securing just the bottom of the seat alone. All seats being produced right now require that top tether; the current invention is the only invention that has a rigid mount that would also mount the top of the seat without the need of the tether.

### ADVANTAGES

Advantages of a rigid mounting device for a child safety seat:
1. Much faster mounting and dismounting.
2. much easier and less frustrating mounting and dismounting
3. much more safely and securely mounted
4. much less room for user variability in mounting
5. eliminates wear and tear on vehicle seat surfaces because child safety seat is actually held off of the seat surface by the rigid mounting system.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A device to secure a child safety seat comprising: a safety seat frame with mounting hooks and mounting spikes.

2. The device as in claim 1, wherein said mounting spikes extend perpendicular from said safety seat frame.

3. The device as in claim 1, wherein said mounting hooks connect to a mounting bracket and said mounting spikes go through receiving holes in a vehicle seat.

4. The device as in claim 1, wherein said mounting spikes have securing latches.

5. The device as in claim 4, wherein said securing latches have tension means pushing out for said mounting spike.

6. The device as in claim 4, wherein said securing latches compress while said mounting spikes go through said receiving hole and extend after going through said receiving holes to secure the safety seat frame to the vehicle seat.

7. The device as in claim 4, wherein said safety seat frame has a release mechanism to compress said securing latches.

8. The device as in claim 1, wherein said safety seat frame has a base support rectangular frame.

9. The device as in claim 8, wherein said safety seat frame has a pair of bottom support bars extending from said base support rectangular frame.

10. The device as in claim 8, wherein said safety seat frame has a pair of arm support bars extending from said base support rectangular frame.

11. The device as in claim 4, wherein said safety seat frame has a release mechanism to compress said securing latches and said release mechanism is attached to said securing latches through a cable where said cable runs through a plurality of pulleys.

12. A device to secure a child safety seat comprising: a safety seat frame with mounting hooks which connect to mounting brackets in a vehicle seat and mounting spikes where said mounting spikes have securing latches and said mounting spikes go through receiving holes in a vehicle seat.

13. The device as in claim 12, wherein said mounting spikes extend perpendicular from said safety seat frame.

14. The device as in claim 12, wherein said securing latches compress while said mounting spikes go through said receiving hole and extend after going through said receiving holes to secure the safety seat frame to the vehicle seat.

15. The device as in claim 12, wherein said safety seat frame has a release mechanism to compress said securing latches.

16. The device as in claim 12, wherein said safety seat frame has a base support rectangular frame.

17. The device as in claim 16, wherein said safety seat frame has a pair of bottom support bars extending from said base support rectangular frame.

18. The device as in claim 16, wherein said safety seat frame has a pair of arm support bars extending from said base support rectangular frame.

19. A device to secure a child safety seat comprising: a safety seat frame with mounting hooks that attach to mounting brackets on a vehicle seat, mounting spikes extending perpendicular from said safety seat frame where said mounting spikes have securing latches and said mounting spikes go through receiving holes in a vehicle seat, where said securing latches compress while said mounting spikes go through said receiving hole and extend after going through said receiving holes to secure the safety seat frame to the vehicle seat, where said safety seat frame has a release mechanism to compress said securing latches where said safety seat frame has a base support rectangular frame, where said safety seat frame has a pair of bottom support bars extending from said base support rectangular frame, where said safety seat frame has a pair of arm support bars extending from said base support rectangular frame.

20. The device as in claim 19, wherein said safety seat frame has a release mechanism to compress said securing latches and said release mechanism is attached to said securing latches through a cable where said cable runs through a plurality of pulleys.
